(19) United States
(12) Patent Application Publication
(10) Pub. No.: US 2010/0016080 A1
(43) Pub. Date: Jan. 21, 2010

(54) REWARDING MULTIPLE VIEWS OF ADVERTISEMENTS WITH A REDEEMABLE MULTIPART COUPON WITHIN A VIDEO GAME

(75) Inventors: Alexander John Garden, Vancouver (CA); Charles Michael Osieja, North Vancouver (CA)

Correspondence Address: DARBY & DARBY P.C., P.O. BOX 770, Church Street Station, New York, NY, 10008-0770, US

(73) Assignee: Nexon Publishing North America, Inc., Vancouver (CA)

(21) Appl. No.: 12/177,028

(22) Filed: Jul. 21, 2008

(51) Int. Cl. A63F 13/00; A63F 9/24; G06F 17/00

(52) U.S. Cl. 463/41; 463/42; 463/40; 463/43

(57) ABSTRACT

Embodiments are directed to providing a video game environment with interactive advertisement objects configured to provide a game player with an advertisement. If the player reaches a defined game decision point with the game, the interactive advertisement object is displayed or otherwise provided to the player. If the player then activates the interactive advertisement object, an advertisement is provided to the game player for viewing, and a field within a multipart coupon may be filled with a unique code based on identities of the player, the game, and at least one of the advertisements or an advertiser of the advertisement. The player may then redeem the coupon for a product and/or service, where at least a portion of the product/service is charged to the associated advertiser.

### FIELD OF THE INVENTION

The present invention relates generally to providing a video game environments, and more specifically, but not exclusively, to providing an interactive advertisement object within a video game that enables access to a redeemable coupon by a player.

### BACKGROUND

Computing gaming has been a multibillion dollar industry. Such games include online games, casual games, social networking type games, downloadable games, and a myriad of other types of games. Some studies have shown that one-third of Internet users play online games at least once a week, with millions of children and teenagers playing games across a variety of different network sites.

However, while the industry appears to still be making money, some studies appear to indicate that the industry is facing financial strains as it attempts to compensate its talent, manage piracy concerns, gray-markets, and the like, while continuing to turn a profit. Thus, many game manufacturers have been looking to different approaches to remaining profitable. One such approach has been through advertisements of various products and services. For example, many games today have been created around a movie, a product, service, or the like. The intent of which is to seek money from advertisements for games which are often manifestations of the movie, or some other product. However, game manufacturers, and advertisers, still seek ways of providing advertisements to the-game players that are not viewed as annoying and/or otherwise distracting to the player. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention; and

FIG. 4 illustrates a logical flow diagram generally showing one embodiment of a process for providing an interactive advertisement object within a game that may be activated by a player to access a redeemable multipart coupon.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” As used herein, the terms “device input” or “user input” refer to a user input command at a device.

As used herein, the term “web content” refers to any data displayable within a markup language document, employing for example, Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like. As used herein, the term “hyperlink” refers to an addressing component that enables retrieving data over a network, including a Uniform Resource Identifier (URI), Uniform Resource Locator (URL), or the like.

As used herein, the terms “multimedia” and “multimedia content” refer to any audio/video digital content accessible at a computing device. Such multimedia includes, but is not limited to videos, audio files, animation files, graphics, streaming content, portions of a video game, television clips, movies, news clips, and the like. Moreover, multimedia is independent of the format in which the multimedia is embodied.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly, various embodiments are directed towards providing a video game environment with interactive advertisement objects that are configured to provide a game player with an advertisement. In one embodiment, a video game may include a plurality of different interactive advertisement objects that may be accessed during play of the game. In one embodiment, the interactive advertisement objects (or simply, interactive objects) may be integrated within the game, appearing as an article of clothing, door, weapon, soda can, an avatar, virtually any inanimate object, or the like. As the player plays the game, a defined game decision point may be reached where an interactive advertisement object may be displayed or otherwise provided to the player. If the player then selects to active the interactive advertisement object, an advertisement may be provided to the player for viewing. In one embodiment, the interactive advertisement object may provide to the player a multipart coupon that may include one or more fields. One of the fields may include a unique code that may be based on identities of the player, the game, and/or the advertisements or an advertiser of the advertisement. In one embodiment, the unique code might be automatically generated and inserted into the coupon for the player. In another embodiment, the player might complete portions of the coupon, filling in selected information. The entered information may then be used to automatically one or more unique codes within the coupon. In any event, the player may then redeem the coupon for a product and/or service. In one embodiment, an advertiser, merchant, or the like, associated with the product and/or service may be charged a fee at least in part for the advertisement placement, viewing of the advertisement by the player, redemption of the coupon, or the like.

### Illustrative Operating Environment

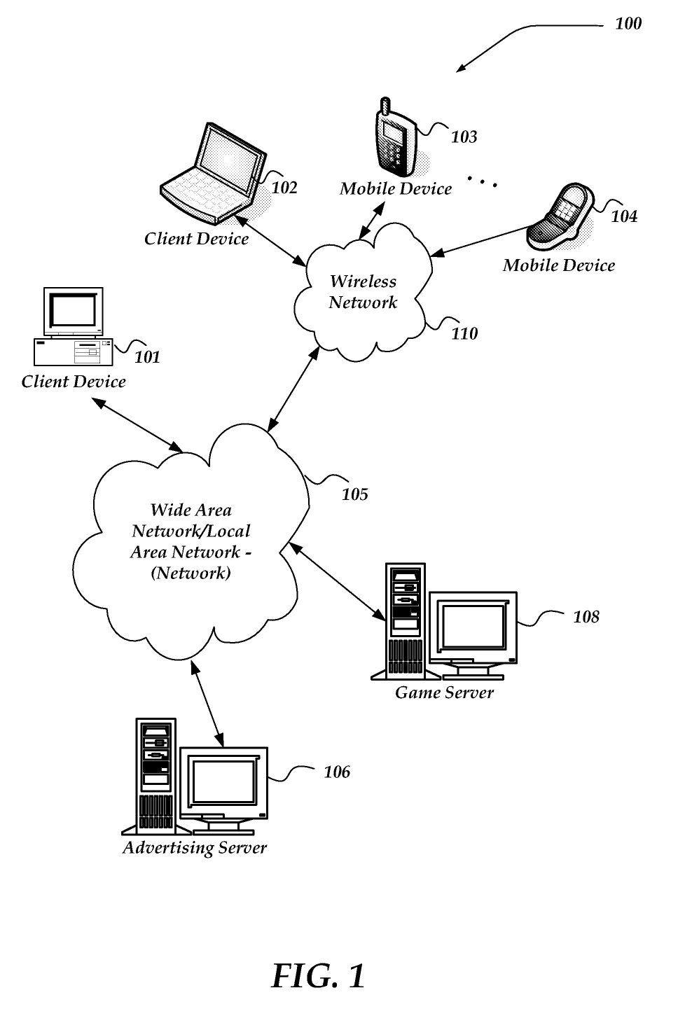

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, advertising server 106, and game server 108.

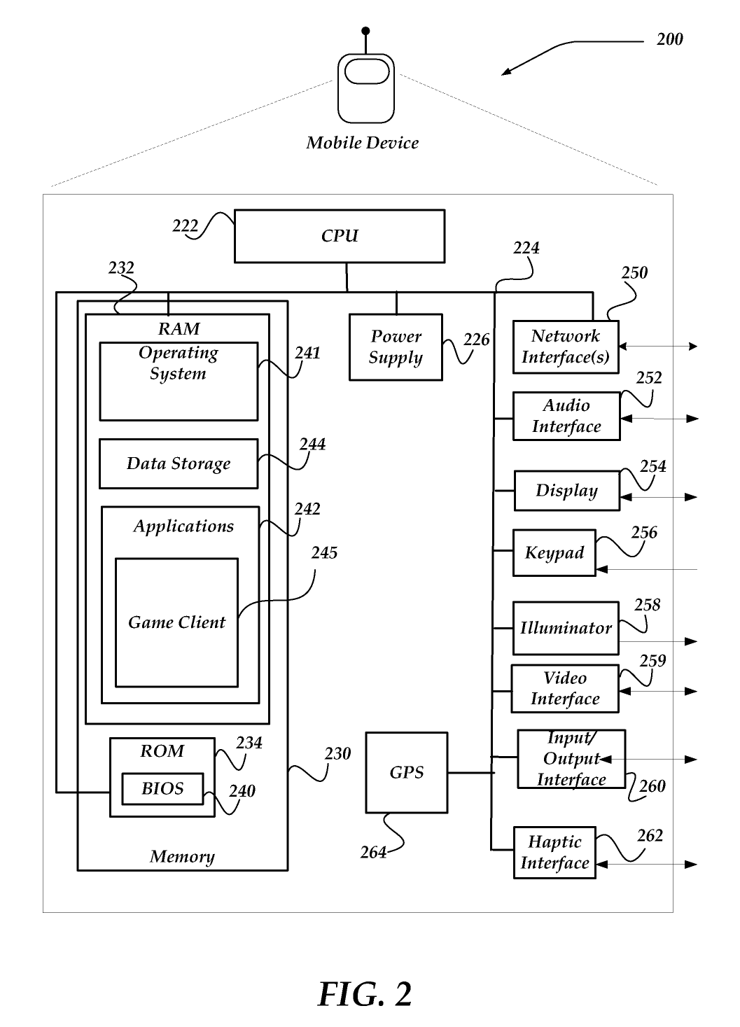

One embodiment of a client device useable as one of client devices 101-104 is described in more detail below in conjunction with FIG. 2. Generally, however, client devices 102-104 may include virtually any mobile computing device capable of receiving and sending a message over a network, such as wireless network 110, or the like. Such devices include portable devices such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, client devices 101-104 may be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a Wireless Application Protocol (WAP) message, or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send a message.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), network address, or other device identifier. The information may also indicate a content format that the client device is enabled to employ. Such information may be provided in a message, or the like, sent to another computing device.

Client devices 101-104 may also be configured to communicate a message, such as through email, Short Message Service (SMS), Multimedia Message Service (MMS), instant messaging (IM), Internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device, such as game server 108, advertising server 106, or the like. Such user account, for example, may be configured to enable the user to receive emails, send/receive IM messages, SMS messages, access selected web pages, participate in a social networking activity, provide messages that may include hyperlinks or attachments, or the like. However, managing of messages may also be performed without logging into the user account.

In one embodiment, client devices 101-104 may be employed to allow a user to play a video game, view an advertisement, and/or manage use of a multipart coupon. Client devices 101-104 may provide the video game to a game player (user of client devices 101-104). In one embodiment, client devices 101-104 may receive the video game as a download over a network. However, in another embodiment, client devices 101-104 may also allow a user to access and play an interactive real-time video game over networks 105 and/or 110 from game server 108, or other network device. In one embodiment, client devices 101-104 may receive an update message about a state of the video game. Such update messages may include, but are not limited to changes to a configuration of the game, changes digital rights access to the game, or the like. For example, in one embodiment, the update changes might include information about new advertisements, changes to existing advertisements, changes to coupons, or the like.

During play of the game, the player may satisfy a defined decision point which is configured to provide to the player one or more interactive objects. In one embodiment, the client device may download the interactive object from over networks 105 and/or 110. In another embodiment, the interactive object may be included within a portion of the game, a data store associated with the game, or similar component, residing on the client device.

The interactive object may be any of a variety of shapes, sizes, and/or representations within the game. Client devices 101-104 may enable the game player to activate the interactive object. The activation of the interactive object may enable the player to proceed with the game. However, the activation of the interactive object further triggers an advertisement that is then presented to player. The advertisement may be stored locally at the client device, or accessed remotely for display over networks 105 and/or 110 from game server 108 and/or advertising server 106. The advertisement may be provided in any of a variety of forms or formats, including, but not limited to an audio file, a multimedia file, a text message, a graphic, a video file, or the like. In one embodiment, the advertisement might be presented through various actions of a character within the game. In another embodiment, the advertisement might include or be accessed by a URL, or other network linking mechanism. It should be clear, however, an advertisement may be accessed or otherwise presented to a player using a variety of mechanisms, and the invention therefore, should not be limited to a particular mechanism.

Client devices 101-104 may also receive a multipart coupon over networks 105 and/or 110. In one embodiment, the coupon might be made accessible to the player upon completion of viewing of the advertisement. In another embodiment, the player might be requested to perform an action to obtain the coupon, including, but not limited on clicking on an icon, button, selecting a URL, or the like. In one embodiment, the player might provide information in response to blank fields within the coupon. For example, the player might enter a name, a pass code, an email address, or the like, into one or more fields within the coupon. In one embodiment, at least some information may be pre-filled automatically for the player. In one embodiment, information provided may be used to generate a unique code. For example, the player might enter a name, email address, or the like, which might then be combined with other information, such as an advertisement number, or the like. The combined information might be encrypted to maintain privacy. In one embodiment, client devices 101-104 may then send the modified coupon back to game server 108, and/or advertising server 106, for further processing. In another embodiment, client devices 101-104 may send an indication that the advertisement has been viewed by a player to game server 108 and/or advertising server 106. Game server 108 and/or advertising server 106 may then manage the unique code and/or multipart coupon. Client devices 101-104 may also enable the game player to purchase a product or service using the multipart coupon. For example, in one embodiment, a link might be provided that links the player to a merchant website, or the like, where the player may then use the coupon to purchase a product or service. However, the invention is not limited to redeeming the coupon outside of the game. Thus, for example, the coupon may be useable to obtain various benefits from within the game. Non-exhaustive examples, include but are not limited, to providing the player with additional game points, game weapons, revealing hidden secrets, or the like, within the game. In any event, in one embodiment, use of the coupon may be sent over networks 110 and/or 105 to a network device for further processing.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple advertising server 106 and its components with other computing devices, including, game server 108, client device 101, and through wireless network 110 to client devices 102-104. Network 105 is enabled to employ any form of computer processor readable media for communicating information from one electronic device to another. Also, network 105 can include the Internet in addition to local area networks (LANs), wide area networks (WANs), direct connections, such as through a universal serial bus (USB) port, other forms of computer processor readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer processor readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

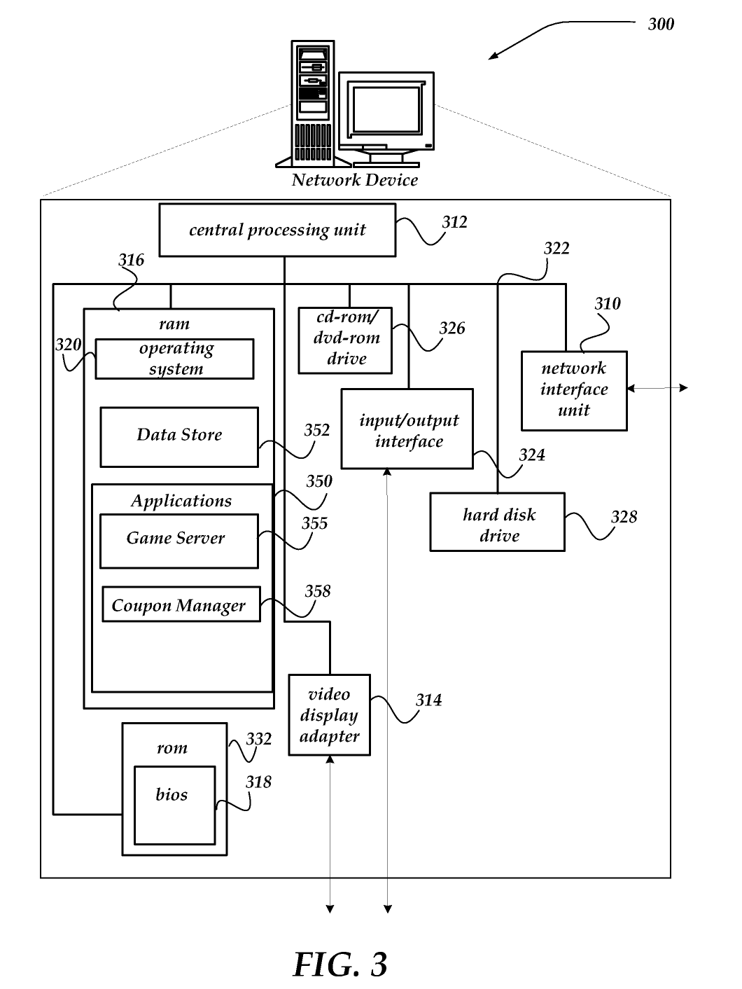

One embodiment of game server 108 is described in more detail below in conjunction with FIG. 3. Briefly, however, game server 108 may include any computing device capable of connecting to network 105 to enable playing a video game, providing an advertisement, and/or managing a multipart coupon. Game server 108 may provide a video game over networks 110 and/or 105 to one or more of client devices 101-104. In one embodiment, game server 108 might enable client devices 101-104 to download the video game, advertisement, coupon, or the like, to be executed at the client device. For example, in one embodiment, game server 108 might provide a game client to client devices 101-104. In another embodiment, game server 108 might enable remote access to the video game, or the like.

Game server 108 may further provide multimedia objects usable in playing the video game by client devices 101-104. Game server 108 may also provide messages to update a state of the game over networks 110 and/or 105. Game server 108 may also receive various control inputs, event inputs, data, and the like, from client devices 101-104 over networks 110 and/or 105 that may change the state of the game, according to a game logic, for example.

Game server 108 may also provide an interactive object to a game player on one of client devices 101-104 over networks 110 and/or 105. Game server 108 may receive, in one embodiment, an indication that the interactive object is activated. Gamer server 108 may retrieve an advertisement from advertising server 106 and send the advertisement to client devices 101-104. In one embodiment, game server 108 may receive status of the completion of the advertisement and thereafter, provide a multipart coupon to client devices 101-104. However, in another embodiment, the coupon might be sent with the advertisement.

In one embodiment, game server 108 may manage filling in the multipart coupon with a unique code. In another embodiment, game server 108 may receive a modified multipart coupon from client devices 101-104, where the player completed at least a portion of the coupon prior to sending to game server 108. In one embodiment, game server 108 may also receive status that the player has redeemed the coupon for purchase of a product or service.

In one embodiment, game server 108 may enable a game designer to update the video game, edit and/or modify graphics, interactive objects, game design, game play, or the like. Game server 108 may receive the update of the video game from client devices 101-104 over networks 110 and/or 105.

Advertising server 106 includes any component configured to manage advertisements over network 105. Advertising server 106 may enable an advertiser to create and/or otherwise manage an advertisement. Advertising server 106 may provide the advertisements as messages, such as emails, SMS messages, IM messages; hyperlinks to a website; downloadable files, or the like. Virtually any content and/or form of content useable to provide an advertisement of a product and/or service may be available through advertising server 106 for access by client devices 101-104 and/or game server 108.

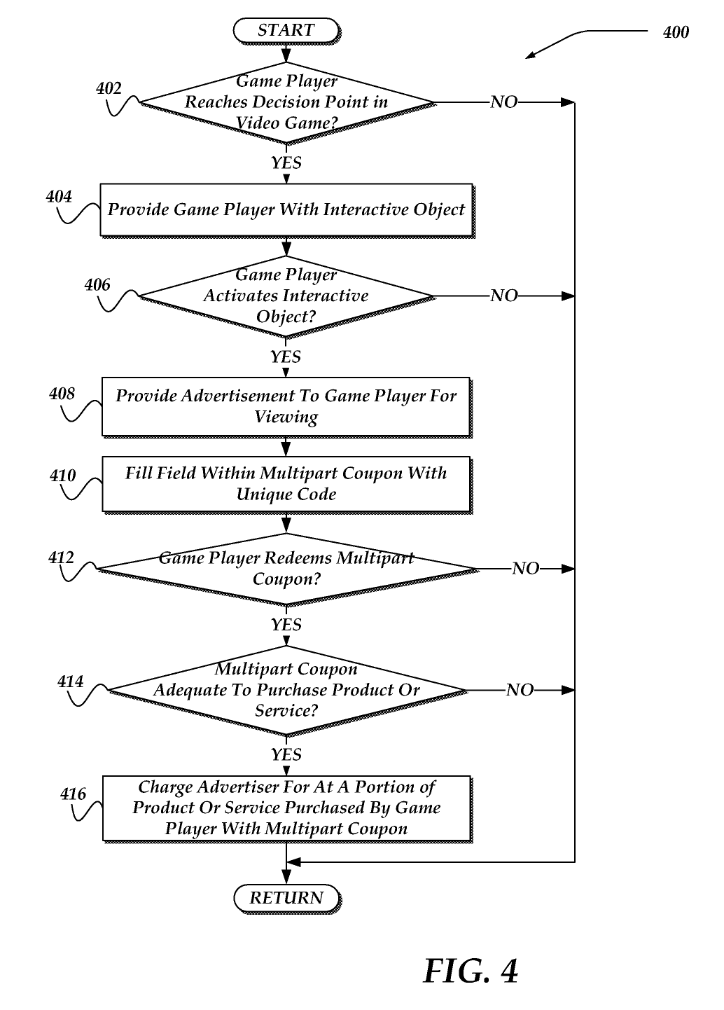

Advertising server 106 and/or game server 108 may employ a process substantially similar to the process described below in conjunction with FIG. 4 to perform at least some of its actions. Devices that may operate as advertising server 106 and/or game server 108 include personal computers, desktop computers, multiprocessor systems, microprocessor-based or programmable consumer electronics, network PCs, servers, or the like.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, one of client devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer processor readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store personal information including but not limited to address lists, contact lists, personal preferences, or the like. Data storage 244 may also include some profile information. At least a portion of the information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may also include game client 245.

Game client 245 may include virtually any computing component or components configured and arranged to manage and display a video game and/or to retrieve an input for the video game. In one embodiment, game client 245 may be a standalone application. However, in another embodiment, game client 245 may be configured to interact with a remote component, such as available over a network. Game client 245 may display graphics, enable login, manage scoring, and/or enable a player to perform other actions associated with play of a video game. Game client 245 may receive controls from the player including, but not limited to keyboard inputs from keypad 256, mouse control from input/output interface 260, or the like, and may process and send command information over network interfaces) 250. Game client 245 may also display an interactive object at a decision point within a game play of the video game. The interactive object may enable the game player to activate the interactive object using an input to mobile device 200, view an advertisement on display 254, or the like. Game client 245 may also display a multipart coupon on display 254, fill a portion of the multipart coupon with a unique code, display an indication of the filling, and/or enable the game player to redeem a multipart coupon in exchange for a product or service. In one embodiment, game client 245 may perform the actions of process 400 of FIG. 4 in conjunction with another network device.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, advertising server 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer processor readable media, namely computer storage media. Computer storage media may include volatile, nonvolatile, removable, and non-removable media implemented in any method or technology for storage of information, such as computer processor readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include game server 355 and coupon manager 358.

Game server 355 may include virtually any computing component or components configured and arranged to create, modify, and/or provide a video game. In one embodiment, the video game may be provided on video display 314, over network interface unit 310, or the like.

Game server 355 may comprise a plurality of sub-components configured to create, modify, and provide the video game. These include, but are not limited to, a game logic engine configured to determine actions for game objects, a graphics and sound engine configured to display objects and provide sounds for the objects, a player interface(s) configured to manage player events and actions, a game editor configured to arrange objects, levels, and the game logic of the video game, and the like. In one embodiment, information used to configure the sub-components of game server 355 and/or the interactive object may be stored within network device 300 (e.g., on hard disk drive 328), or may be retrieved over network interface unit 310.

In one embodiment, game server 355 may enable a game designer, an editing tool, an Application Programming Interface (API), or the like, to define one or more decision points within the game play of the video game to provide an interactive object. The interactive object may be specified using the API, editing tool, or the like, and may be configured to provide an advertisement. For example, at a decision point where a player is required to use a warm jacket, an interactive object associated with an advertisement of a “Clothing” type may be provided. In another example, the game might provide other interactive objects, such as a weapon, an avatar, a soda pop can, car, door, or the like, that upon interacting with the interactive object, an advertisement might be activated. In one embodiment, the advertisements might be accessible via a network like. However, in another embodiment, the advertisement might be stored in a data store, such as data store 352, a data store residing on the client device, or the like.

During the game play, at the decision point specified, the interactive object may be provided to the game player, the game player may then activate the interactive object. The advertisement and/or multipart coupon may then be presented to the player. In one embodiment, the coupon might be managed and made accessible through coupon manager 358. In another embodiment, the coupon might be stored in data store 352, a data store residing on the client device, or the like. In one embodiment, game server 355 might communicate with coupon manager 358 to obtain and/or deliver the coupon to the player. In one embodiment, coupon manager 358 might provide the coupon to the player, and receive a filled in coupon from the player In one embodiment, coupon manager 358 might receive selected information from the player, and/or game server 355, and employ the selected information to automatically fill in portions of the coupon, and to generate a unique code.

Coupon manager 358 may include virtually any computing component or components configured and arranged to manage a multipart coupon, advertisement, and/or a purchase based on using the multipart coupon. In one embodiment, coupon manager 358 may enable a game designer and/or advertiser to create a multipart coupon template for storing a plurality of unique codes associated with viewing an advertisement, generating the unique code, or the like. Coupon manager 358 may enable configuring the types of the unique code(s) that may be generated and/or stored within the multipart coupon, the value of the unique code(s) and/or multipart coupon, or the like.

Coupon manager 358 may also enable an advertiser to provide an advertisement comprising a multimedia object, a URL, an advertisement type, or the like. Coupon manager 358 may also enable specifying a value for the advertisement. In one embodiment, specified value might be an amount of money paid to a third-party for the user viewing the advertisement, an amount of money for paying a vendor for a purchase using the multipart coupon, a bid for the amount(s), or the like.

Coupon manager 358 may generate a unique code for a game player viewing an advertisement, may fill in a multipart coupon with the unique code, may manage a purchase made by the game player using the multipart coupon, or the like. Game server 355 and coupon manager 358 may perform the actions of process 400 of FIG. 4.

### Generalized Operation

The operation of certain aspects of the invention will now be described with respect to FIG. 4. FIG. 4 illustrates a logical flow diagram generally showing one embodiment of a process for providing an interactive advertisement object within a game that may be activated by a player to access a redeemable multipart coupon. Process 400 of FIG. 4 may be implemented, for example, within game server 108, client devices 101-104, and/or advertising server 106 of FIG. 1.

Process 400 begins at decision block 402, where it is determined whether a game player has reached a decision point in a video game. In one embodiment, a video game may include a plurality of defined decision points within the video game. In another embodiment, however, the video game might include a single decision point. In any event, a game logic of the video game may determine that the player is at a decision point based on a story line, decision tree, whether the game player is at a spatial or logical location in the game, whether the game player's state (e.g., points, health, armor, level, or the like) meets requirements such as thresholds, or the like, or any combination thereof. As non-exhaustive example, a decision point might be reached when a player's avatar is in a particular scene, location, approached by a particular character, or the like. In another non-exhaustive example, a decision point might be satisfied when the player's score, game level, or the like, exceeds a particular threshold. In any event, it should be clear that a defined decision point may be integrated into a game using any of a variety of mechanisms. Thus, the invention is not to be construed as being limited by these non-exhaustive examples and others are clearly envisaged. For example, a decision point might be reached when a particular sound, color, or the like, is encountered by the player's avatar. If it is determined that the game player is at the decision point, processing continues to block 404. Otherwise, processing returns to a calling process for further processing.

At block 404, the game player is provided with an interactive object that is configured to be activated to provide an advertisement. In one embodiment, providing the interactive object comprises changing a display of the video game. In one embodiment, a use of the interactive object may enable the game player to advance in the game. In one embodiment, the interactive object may be non-usable until the player performs actions, including touching the object, speaking to a game character, picking up the object, or the like. Providing the interactive object may include displaying the object to the player at a display screen. In one embodiment, information associated with an advertiser may be displayed on the icon associated with the interactive object.

At block 406, it is determined whether the game player has activated the interactive object. In one embodiment, activation may comprise, pressing a key, a button, entering a text phrase, speaking, making a sound, answering a question, picking up the object, opening a door, stepping on/over the object, or performing any of a variety of other actions that are directed to trigger and activate the object. If the interactive object is activated, processing continues to block 408. Otherwise, processing returns to a calling process for further processing.

At block 408, when the interactive object is activated, an advertisement is provided to the user for viewing or some other form of consumption (e.g., hearing, tactile feeling, or combinations thereof). In one embodiment, the advertisement may be provided over a network. In one embodiment, the advertisement may be provided as a display of visual, audio, tactile information encompassing at least a portion of the display and/or audio channel of a device. In one embodiment, the advertisement may be a video, played, for example, within the video game environment, or even outside the video game environment. In one embodiment, the advertisement may be accessed through a Uniformed Resource Locator (URL), clicking on or otherwise selecting providing an object pointed to by the URL (e.g., Flash file, video, image, sound, web-page), or the like.

At block 410, a coupon may be provided for access to the game player. In one embodiment, the coupon may include multiple parts, where the parts may include pre-filled fields, blank fields to be filled by the player, and/or a combination of the pre-filled and/or blank fields. In one embodiment, information that the player may have provided already, including, but not limited, to a name, and/or other user information might be used to automatically generate a unique code for use with the coupon. In another embodiment, the information might further include information about the game, advertisement, merchant, or the like. Then, one or more of this information, and/or one or more of the user information may be combined to generate the unique code. The unique code may also be generated based on information about the game player, the advertisement, the advertiser, the video game, video game type, game level, or any combination thereof. In one embodiment, the unique code may be based on identities of the game player, a game, and at least one of the advertisements, an advertiser of the advertisement, or the like. In one embodiment, the code may be a hash of a combination of the one or more of the above information. In another embodiment, the code may be encrypted to inhibit disclosure of private player information, or other information. In any event, the code is configured to in a way that there is a very low probability that another unique code for different information would result in the same code. In any event, the unique code is configured to prevent spoofing and/or sharing of the unique code, or otherwise cheating. In one embodiment, filling the multipart coupon may be conveyed visually in a window with a slot of the multipart coupon being filled with a number for the unique code.

In one embodiment, the code might be inserted automatically into the coupon. In one embodiment, the player might complete one or more of the blank fields, the provided player information in the fields then being useable to generate one or more unique codes for the coupon. In one embodiment, the one or more unique codes may be visible to the player. However, in another embodiment, the one or more unique codes may be hidden within the coupon, such that the player might not readily view the codes.

In one embodiment, the multipart coupon may be configured and arranged such that at least one part is associated with a different advertiser and/or advertisement than another part. Thus, in one embodiment, each of the different multiple parts might also include at least one different unique code. However, the invention is not so limited. For example, in another embodiment, the multiple parts of the coupon may be associated with different information provided by the player, but associated with a single advertiser/advertisement. Thus, the multipart coupon is not constrained to a single configuration, and different configurations and arrangements of information within the multipart coupon may be employed, without departing from the scope of the invention.

In any event, processing continues to decision block 412, where it is determined whether the game player has redeemed the multipart coupon. In one embodiment, the multipart coupon may be usable, and the player is rewarded with the multipart coupon, as soon as at least one portion of the multipart coupon is filled with a unique code. In another embodiment, the game player is rewarded with the multipart coupon that is usable to exchange for the product or service, if the multipart coupon indicates a plurality of viewed advertisements by the game player. In one embodiment, redeeming may comprise enabling the game player to provide the multipart coupon in exchange for a product or service. In one embodiment, the product or service may comprise at least one of a game object, a life point, a retail item, an account for playing in the video game environment, or the like.

The multipart coupon may be provided within the video game, or even outside of the video game. The game may provide a button, entry screen, or other entry mechanism to provide the multipart coupon. For example, after watching the advertisement, a screen to redeem the filled multipart coupon may be provided. In another embodiment, the multipart coupon may be used outside the video game, such as using a website, an c-commerce store, an email, or even at a physical store. The multipart coupon may be exchanged for store credit, or used as cash. If it is determined that the game player has redeemed the multipart coupon, processing continues to decision block 414. Otherwise, processing returns to a calling process for further processing.

At decision block 414, it is determined whether the multipart coupon is adequate to purchase the product or service. In one embodiment, a value may be determined for the multipart coupon, based on, for example, number of unique codes filled within the multipart coupon, types of unique codes filled, type of user, whether a number of filled slots of the multipart coupon reaches a threshold, number of times the multipart coupon has been redeemed, a time between the rewarding of the multipart coupon and the redeeming of the multipart coupon, and the like. In one embodiment, the value of the multipart coupon may be compared to the price (e.g., in money, game credits, points) of the product or service to be purchased. In one embodiment, if the value meets the price, it is determined that the multipart coupon is adequate to purchase the product or service. Other mechanisms for determining adequacy of the coupon may be used without departing from the scope of the invention. If it is determined that the multipart coupon is adequate to purchase the product or service, processing continues to block 412. Otherwise, processing returns to a calling process for farther processing.

At block 412, at least one advertiser associated with at least one unique code, the game player, and/or the multipart coupon is charged for a product or service to be provided to the game player. In one embodiment, at least one of the advertisers may be billed for at least a portion of another price for the product or service. In one embodiment, the other price may be the price used in decision block 414, but in another embodiment, may be a different price, such as a wholesale price, a discounted price, or the like. In one embodiment, the price may be billed proportionately to at least one advertiser (e.g., by the value of each unique code, advertisement seen, or the like). In another embodiment, the price may be billed equally to each of the advertisers. In one embodiment, the product or service is provided to the user at block 412 and/or after block 414. In an alternate embodiment, metrics about the game player, such as the purchase made, the multipart coupon, the preference of games, the realizations on advertisements seen, or the like, may be provided (e.g., to an advertiser, data-base, or the like). Processing then returns to a calling process for further processing.

It will be understood that each block of a flowchart illustration need not be limited to the order shown in the illustration, and might be performed in any order, or even performed concurrently, without departing from the spirit of the invention. It will also be understood that each block of the flowchart illustration, and combinations of blocks in the flowchart illustration, can be implemented by computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter.

What is claimed as new and desired to be protected by Letters Patent of the United States is:

1. A method for providing a video game environment, comprising:
enabling a player to play a video game;
if during play of the video game a defined game decision point is reached, providing to the game player an interactive advertisement object;
if the game player activates the interactive advertisement object:
providing an advertisement to the game player; and
filling in at least one field within a multipart coupon with a unique code that is based on at least one of a game player identity, a game identity, an identity of the advertisement, or identity of an advertiser associated with the advertisement; and
if the game player redeems the multipart coupon, enabling the advertiser to be charged for at least a portion of a purchase of a product or service by the game player.

2. The method of claim 1, wherein filling in at least one field further comprises:
automatically and without intervention by the game player, filling in the at least one field with the unique code, wherein the unique code is an encrypted combination of at least two of the identities.

3. The method of claim 1, wherein the product or service comprises at least one of:
a game object, a life point, a retail item, or an account for playing in the video game environment.

4. The method of claim 1, wherein reaching the defined game decision point further comprises encountering at least one of an object within the video game, reaching a defined game level, or performing a defined action.

5. The method of claim 1, wherein activating the interactive advertisement object further comprises performing an interaction with the interactive advertisement object using at least one computer input device.

6. The method of claim 1, further comprising:
if the multipart coupon indicates a plurality of viewed advertisements by the game player, rewarding the game player with the multipart coupon before charging the advertiser.

7. A network device for providing data over a network, comprising:
a transceiver for communicating data; and
a processor configured to perform actions comprising:
enabling a game player to execute and play a computer game;
if during play of the video game, the game player activates an interactive advertisement object within the video game:
providing an advertisement to the game player with a multipart coupon; and
if the game player redeems the multipart coupon, charging an advertiser a fee based at least on a portion of the redemption.

8. The network device of claim 7, wherein the actions further comprise:
if the game player satisfies a defined criteria, providing a display of the interactive advertisement object to the game player.

9. The network device of claim 7, wherein the redemption of the multipart coupon enables the game player to obtain at least one of a game object, a life point, or a product or service purchasable outside of the computer game.

10. The network device of claim 7, wherein the interactive advertisement object further comprises at least one of a game object, or a game character.

11. The network device of claim 7, wherein the providing the advertisement with a multipart coupon further comprises:
obtaining at least one of the advertisement or the multipart coupon using a network linking mechanism.

12. The network device of claim 7, wherein the multipart coupon further comprises at least one part for a first advertisement or first advertiser, and a second part for a second advertisement or second advertiser, wherein the first and second advertisement or advertiser are different.

13. A mobile device for providing a video game environment, comprising:
memory configured to store data and instructions for a video game, the video game having a plurality of defined decision points, each decision point being associated with at least one advertisement; and
a processor configured to execute at least some of the stored instructions to perform actions comprising:
enabling a game player to play the video game;
if during play of the video game a defined game decision point within the plurality of defined decision points is reached, providing the at least one associated advertisement to the game player; and
receiving from the game player information that is useable to generate a unique code;
generating the unique code by combining the game player information with at least one of an identity of the game, identity of the advertisement, or identity of an advertiser or merchant associated with the advertisement;
inserting the unique code into a multipart coupon that is useable by the game player for redemption of at least one of a product or service; and
based at least on the redemption of the multipart coupon, charging the advertiser or merchant a fee.

14. The mobile device of claim 13, wherein the unique code is a hash code of at least two of the identities.

15. The mobile device of claim 13, wherein the product is an interactive object usable within a video game environment.

16. A system for providing a video game environment over a network, comprising:
a coupon manager component configured to perform actions comprising:
providing access to a video game for play by a game player, the video game having at least one interactive advertisement object that is associated with an advertisement;
receiving a multipart coupon for redemption; and
charging a fee to an advertiser identified within the multipart coupon based at least on the redemption; and
a client game component configured to perform actions comprising:
enabling the game player to activate the at least one interactive advertisement object, such that the advertisement is played at a client device;
providing to the game player the multipart coupon such that the game player may provide selected information;
encoding into the multipart coupon a unique code based on the provided information, and at least one of an identity of the advertiser associated with the advertisement, or a game identity; and
enabling the game player to redeem the multipart coupon for a product or service.

17. The system of claim 16, wherein the unique code is a hash code of at least two of the identities.

18. The system of claim 16, wherein the product is an interactive object usable within the video game environment.

19. A processor readable medium for providing a video game environment, comprising processor readable instructions that are executed by a processor to perform actions comprising:
if a game player reaches a game decision point within the video game environment providing to the game player an interactive object;
if the game player activates the interactive object:
providing an advertisement; and
a multipart coupon with a unique code that is generated based on identities of the game player, a video game, and at least one of the advertisement or an advertiser of the advertisement; and
charging the advertiser for a product or service provided to the game player, if a number of filled fields of the multipart coupon reaches a threshold.

20. The processor readable medium of claim 19, wherein the reaching the game decision point further comprises at least one of satisfying a threshold level within the video game, encountering a game object or game character, being within a defined location of the video game environment, or having a defined game state.
